(19) United States
(12) Patent Application Publication
(10) Pub. No.: US 2003/0230642 A1
(43) Pub. Date: Dec. 18, 2003

(54) Sprayer with removable ink

(76) Inventor: Han-Shin Jung, Taejeon-City (KR)

Correspondence Address: HARNESS, DICKEY & PIERCE, P.L.C., P.O. BOX 8910, RESTON, VA, 20195, US

(21) Appl. No.: 10/401,723

(22) Filed: Mar. 31, 2003

(30) Foreign Application Priority Data
May 31, 2002 (KR) 2002-0016826

(51) Int. Cl. B05B 7/32

(52) U.S. Cl. 239/337

(57) ABSTRACT

Disclosed is a sprayer with removable ink to be sprayed onto the non-absorptive surface of a car or a glass when it is needed to make various designs thereon, and removed when it is no longer required. The sprayer includes a barrel-shaped pressure vessel, a spray nozzle mounted at the top of the pressure vessel, an absorption tube connected to the spray nozzle while being placed within the pressure vessel, a push button placed over the pressure vessel to open or close the spray nozzle, a gas charged into the pressure under a predetermined degree of pressure, and a removal ink charged into the pressure vessel while containing a solvent, a resin dissolved in the solvent, an exfoliation agent, and a coloring agent. The amount of the solvent is established to be 10-80 wt %, the amount of the exfoliation agent to be 0.5-20 wt % and the amount of the coloring agent to be 1-50 wt %. The remaining content of the removable ink is occupied by the resin together with additives such as a moisture control agent, a surface active agent, an antiseptic agent, an antirust agent, and a pH control agent.

### BACKGROUND OF THE INVENTION

(a) Field of the Invention

The present invention relates to a sprayer with removable ink and, more particularly, to a sprayer with removable ink which is sprayed onto the non-absorptive surface of a car or a glass when it is needed to make various designs thereon, and removed when it is no longer required.

(b) Description of the Related Art

Generally, a sprayer is structured such that a content of liquefied chemicals such as insecticide and medicine, paints or cosmetics is charged into a pressure vessel together with a gas under a predetermined degree of pressure, and sprayed by way of the pressure of the gas when the push button mounted over the vessel is pushed.

A sprayer with paint is mainly used to express the location of traffic accidents, to coat the coating-detached area of the car, and to paint the metal or the wood.

However, with the conventional spray with paint, it is impossible to remove the paint once coated.

Therefore, such a sprayer may be used only in case it is intended to maintain the coating in a semi-permanent manner.

Recently, many peoples possess their own cars, and they are inclined to express their specific characters by attaching various prominent accessories or stickers to their cars.

Particularly in the case of the wedding car for the just-married couple or the special event car, various kinds of decorations are made on the car surface using ribbons or bands.

### SUMMARY OF THE INVENTION

It is an object of the present invention to provide a sprayer with removable ink which can be sprayed onto the non-absorptive surface of a car or a glass when it is needed to make various designs thereon, and removed when it is no longer required.

This and other objects may be achieved by a sprayer with the following features.

The sprayer includes a barrel-shaped pressure vessel, a spray nozzle mounted at the top of the pressure vessel, an absorption tube connected to the spray nozzle while being placed within the pressure vessel, a push button placed over the pressure vessel to open or close the spray nozzle, a gas charged into the pressure under a predetermined degree of pressure, and a removal ink charged into the pressure vessel while containing a solvent, a resin dissolved in the solvent, an exfoliation agent, and a coloring agent.

The amount of the solvent is established to be 10-80 wt %, the amount of the exfoliation agent to be 0.5-20 wt % and the amount of the coloring agent to be 1-50 wt %. The remaining content of the removable ink is occupied by the resin together with additives such as a moisture control agent, a surface active agent, an antiseptic agent, an antirust agent, and a pH control agent.

With the removable ink, the solvent is selected from alcoholics such as ethanol, propanol, isopropanol, butanol and isobutanol, glycol ethers such as methyl glycol, butyl glycol, propylene glycol monomethylether, propylene glycol and monoethylether, esters such as butyl acetate and ethyl acetate, or ketones such as methyl ethyl ketone and methyl isobutyl ketone. The exfoliation agent is selected from longer chain fatty esters, being in a liquefied state at ambient temperature, such as isocetyl isostearate and isocetyl palmitate. The coloring agent is selected from pigment or dyes, or fluorescent pigments where polyvinyl chloride, polyimide, benzoguanamine or melamine is used for the base resin.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawing in which like reference symbols indicate the same or the similar components, wherein:

FIG. 1 is a partial side elevation view of a sprayer with removable ink according to a preferred embodiment of the present invention.

### DETAILED DESCRIPTION OF THE PREFERRED EMBODIMENTS

Preferred embodiments of this invention will be explained with reference to the accompanying drawings.

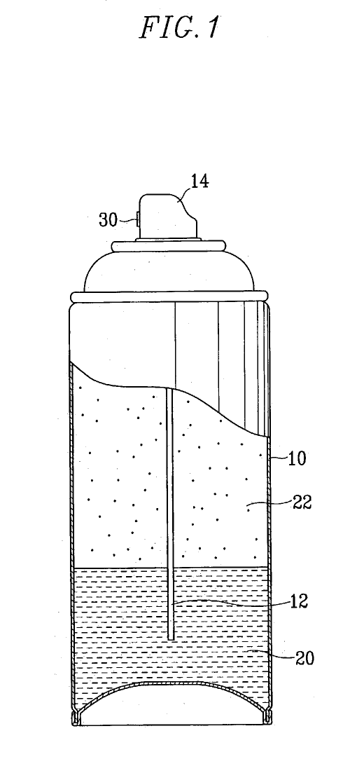

FIG. 1 is a partial side elevation view of a sprayer with removable ink according to a preferred embodiment of the present invention.

As shown in FIG. 1, the sprayer includes a barrel-shaped pressure vessel 10, a spray nozzle 30 mounted at the top of the pressure vessel 10, an absorption tube 12 connected to the spray nozzle 30 while being placed within the pressure vessel 10, a push button 14 placed over the pressure vessel 10 to open or close the spray nozzle 30, and a gas 22 charged into the pressure vessel 10 under a predetermined degree of pressure, and a removable ink 20 injected into the pressure vessel 10. The removable ink 20 contains a solvent, a resin dissolved in the solvent, an exfoliation agent, and a coloring agent.

The pressure vessel 10, the spray nozzle 30, the absorption tube 12 and the push button 14 may involve the same structure as those components used in the usual sprayer, and hence, detailed descriptions thereof will be omitted.

Various kinds of gases including Freon, LPG and LNG may be used for the gas 22, preferably provided that such a gas does not make any harm to the personal body while reducing the possibility of any environmental pollution.

Furthermore, it is preferable that the gas 22 should be based on the gas the contents of which are not chemically reactant with the removable ink 20.

The gas 22 is charged into the pressure vessel 10 under the predetermined degree of pressure together with the removable ink 20. Before the usage of the sprayer, the pressure vessel 10 is shaken several times until the gas 22 and the removable ink 20 are mixed in a sufficient manner. When the spray nozzle 30 opens by way of the pushing the button 14, the gas 22 is discharged so that the removable ink is sprayed through the spray nozzle 30.

That is, when the inner pressure of the pressure vessel 10 is higher than the atmospheric pressure, with the opening of the spray nozzle 30, the gas is discharged to the outside due to the pressure difference.

The spraying operation of the removable ink accruing to the discharge of the gas 22 is the same as that with the usual sprayer, and hence, the detailed description thereof will be omitted.

With the removable ink 20, the amount of the solvent is established to be about 10-80 wt %, preferably to be about 30-50 wt %.

The solvent is selected from alcoholics such as ethanol, propanol, isopropanol, butanol, isobutanol, glycol ethers such as methyl glycol, butyl glycol, propylene glycol monomethylether, propylene glycol, monoethylether, esters such as butyl acetate and ethyl acetate, or ketones such as methyl ethyl ketone and methyl isobutyl ketone.

The exfoliation agent is selected from esters including longer chain fatty ester, being in a liquefied state at ambient temperature, such as isocetyl isostearate and isocetyl palmitate.

The amount of the exfoliation agent is established to be about 0.5-20 wt %.

The amount of the coloring agent is established to be about 1-50 wt %, preferably to be about 10-30 wt %.

Pigment or dyes may be all used as the coloring agent. Particularly for the decoration purpose, it is preferable to use a fluorescent pigment for the coloring agent.

In case the amount of the fluorescent pigment for the coloring agent is 1 wt % or less, the desired density of fluorescent color cannot be obtained. By contrast, in case it exceeds 50 wt %, the viscosity of the resulting material is increased so much as to make the usage thereof impossible.

The fluorescent pigment is selected from the materials where polyvinyl chloride (PVC), polyimide, benzoguanamine or melamine is used for the base resin.

Other additives for the removable ink may include a resin, a moisture control agent, a surface active agent, an antiseptic agent, an antirust agent, and a pH control agent.

The removable ink is prepared through uniformly mixing the solvent, the exfoliation agent, the coloring agent and the resin using a ball mill or a triple-structured roll.

Examples of the removable ink according to the present invention will be now explained.

### EXAMPLE 1

A removable ink was obtained through mixing ethanol of 60 wt % for the solvent, a fluorescent pigment of 20 wt % coated with polyvinyl chloride for the coloring agent, isocetyl isostearate of 10 wt % for the exfoliation agent, and polyvinyl butyral of 10 wt % for the resin at ambient temperature for one hour, using a ball mill.

### EXAMPLE 2

A removable ink was obtained through mixing ethanol of 50 wt % for the solvent, a fluorescent pigment of 30 wt % coated with polyimide for the coloring agent, isocetyl isostearate of 10 wt % for the exfoliation agent, and polyvinyl butyral of 10 wt % for the resin at ambient temperature for one hour, using a ball mill.

### EXAMPLE 3

A removable ink was obtained through mixing ethanol of 60 wt % for the solvent, a carbon black of 20 wt % for the coloring agent, isocetyl isostearate of 10 wt % for the exfoliation agent, and polyvinyl butyral of 10 wt % for the resin at ambient temperature for one hour, using a ball mill.

The respective removable inks 20 according to Examples 1 to 3 are charged into the pressure vessel 10 with the LPG gas 22. Writings are made on the non-absorptive plate using those inks. The initial removal capacity and the time-passed removal capacity of the inks were tested, and the results are listed in Table 1.

TABLE 1

| | Example 1 | Example 2 | Example 3 |
|---|---|---|---|
| Initial | ◯ | ◯ | ◯ |
| removal capacity | | | |
| Time-passed | ◯ | Δ | Δ |
| removal capacity | | | |

In order to measure the initial removal capacity, writings were made on the target plate, and ten minutes later, the plate was rubbed using a suitable eraser under the load of 200 g. The number of rubbings for the complete removal of the writings was counted. When the removal was made with the rubbings of one or two times, the result is indicated by “O.” When the removal was made with the rubbings of three or four times, the result is indicated by “Δ.” When the removal was made with the rubbings of five or more times, the result is indicated by “X.”

Furthermore, in order to measure the time-passed removal capacity, writings were made on the target plate, and ten days later, the plate was rubbed using a suitable eraser under the load of 200 g. The number of rubbings for the complete removal of the writings was counted. When the removal was made with the rubbings of one or two times, the result is indicated by “O.” When the removal was made with the rubbings of three or four times, the result is indicated by “Δ.” When the removal was made with the rubbings of five or more times, the result is indicated by “X.”

It turns out from Table 1 that the inventive removable ink exhibits excellence in the initial removal capacity as well as in the time-passed removal capacity. That is, the removal of the ink was made through rubbing the ink spots using the eraser three or four times.

Consequently, with the sprayer having a removable ink according to the present invention, the desired design or characters can be depicted on the car glass, the window glass of the house or the display plate of the store through spraying, and after the relevant purpose is satisfied, the ink spots can be removed from those places in an easy manner.

As described above, with the sprayer having a removable ink according to the present invention, various kinds of color designs can be depicted on the glass of the wedding car for the just-married couple, the special event car, the store or the display stand, and after the relevant purpose is satisfied, the ink spots can be removed from those places.

It is possible to expand the usage of the sprayer more widely.

When the fluorescent pigment is used as the coloring agent for the removable ink, fluorescent colors are expressed, and this can induce the curiosity of the users.

However, with the sprayer having a removable ink, notes or emergent communication notes can be written on the surface of the machine or facility, and the ink spots can be removed when unneeded. In this case, as the fluorescent colors are visibly expressed, excellent visibility is obtained so that the relevant information can be notified to other peoples in an effective manner.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A sprayer with a removable ink, the sprayer comprising:
a barrel-shaped pressure vessel;
a spray nozzle mounted at the top of the pressure vessel;
an absorption tube connected to the spray nozzle while being placed within the pressure vessel;
a push button placed over the pressure vessel to open or close the spray nozzle;
a gas charged into the pressure under a predetermined degree of pressure; and
a removal ink charged into the pressure vessel while containing a solvent, a resin dissolved in the solvent, an exfoliation agent, and a coloring agent.

2. The sprayer of claim 1 wherein the amount of the solvent is established to be 10-80 wt %, the amount of the exfoliation agent to be 0.5-20 wt % and the amount of the coloring agent to be 1-50 wt %, and the remaining content of the removable ink is occupied by the resin together with additives such as a moisture control agent, a surface active agent, an antiseptic agent, an antirust agent, and a pH control agent.

3. The sprayer of claim 1 or 2 wherein the solvent is selected from alcoholics such as ethanol, propanol, isopropanol, butanol and isobutanol, glycol ethers such as methyl glycol, butyl glycol, propylene glycol monomethylether, propylene glycol and monoethylether, esters such as butyl acetate and ethyl acetate, or ketones such as methyl ethyl ketone and methyl isobutyl ketone,
the exfoliation agent is selected from longer chain fatty esters, being in a liquefied state at ambient temperature, such as isocetyl isostearate and isocetyl palmitate, and
the coloring agent is selected from pigment or dyes, or fluorescent pigments where polyvinyl chloride, polyimide, benzoguanamine or melamine is used for the base resin.
